(19) United States
(12) Patent Application Publication
(10) Pub. No.: US 2014/0305040 A1
(43) Pub. Date: Oct. 16, 2014

(54) MOBILE PLANT GROWING DEVICE AND KIT

(71) Applicant: JOHN JEFFREY HALL, JACKSON, MI (US)

(72) Inventor: JOHN JEFFREY HALL, JACKSON, MI (US)

(21) Appl. No.: 13/861,063

(22) Filed: Apr. 11, 2013

(51) Int. Cl. A01G 9/02

(52) U.S. Cl. CPC A01G 9/02
USPC 47/65.5

(57) ABSTRACT

A mobile plant growing apparatus includes a table having a bottom section housing a waterproof tray and an upper platform defining an aperture that is positioned above the waterproof tray having a screen secured thereon. A mobile plant growing apparatus also includes a second platform that is removably installed above the first platform. A mobile plant growing apparatus also includes a water conveying channel disposed within the upper platform, an inlet valve and a plurality of openings that function in unison to deposit water and/or gas into the aperture.

### CROSS-REFERENCE TO RELATED APPLICATIONS

This application claims the benefit of U.S. application Ser. No. 61/623,507 filed on 12 Apr. 2012, the contents of which are incorporated herein by reference.

### TECHNICAL FIELD

The present invention relates generally to improved devices and methodologies for growing plants, and more particularly to an apparatus for growing and harvesting various types of medicinal plants.

### BACKGROUND

Indoor growers of medicinal and other types of plants spend untold hours trimming and harvesting crops produced by the plants. This process typically involves placing a potted plant onto a flat surface such as a traditional table, for example, and physically rotating the plant in order to allow the grower access to all of its sides. Although this process works well for smaller plants, it suffers from several drawbacks as the plants become larger in size. As can be appreciated, the larger and heavier the plant becomes, the more difficult it is to physically lift the plant onto a table top and to rotate the same in order to allow the grower to trim all of the plant surfaces.

As is known to those of skill in the art, for many plants, the more light that reaches a plant, the better the plant will grow. When plants are left to grow without manipulation, they will typically grow vertically, resulting in only the uppermost portion of each plant receiving light. When this occurs, the majority of the plant does not yield the maximum possible product, thus resulting in decreased overall crop production.

As such, growers are constantly forced to trim and re-position each plant so that the various branches and leaves are spread out across the widest possible horizontal area, in order to allow maximum light reception across all areas of the plant for triggering photosynthesis. This is particularly true with respect to medicinal plants such as lady ferns, medical marijuana, catnip, and sage for example, which are often grown in small quantities under controlled conditions. To this end, manipulation and repositioning of the plants require large amounts of physical labor which can lead to long term back problems for the growers.

Moreover, it is common for plant growers to flush chemicals from the plants prior to harvesting. This is typically accomplished by physically moving the plant to an outdoor environment where large amounts of water can be applied to the plant. As the water makes its way through the soil, it exits from the bottom of the plant and is dispersed into the outside environment.

Accordingly, it would be beneficial to provide an apparatus for allowing a user to easily transport and manipulate plants without the drawbacks described above. Additionally, it would be desirable to provide the apparatus with a mechanism for maintaining the branches and leaves of an inserted plant in a generally spread out (i.e., horizontal) position so as to increase the amount of light available to the overall surface area of the plant itself. Finally, it would also be beneficial to provide an apparatus capable of housing the plant in the above described manner without requiring a user to remove the plant from the apparatus for purposes such as watering, trimming, flushing, and/or applying products such as CO2 and the like.

### SUMMARY OF THE INVENTION

The present invention is directed to a mobile plant growing apparatus. One embodiment of the present invention can include a table having a bottom section for housing a waterproof tray, and an upper platform positioned above the waterproof tray that includes an aperture covered by a screen.

Another embodiment of the present invention can further include a second platform that is removably installed above the first platform.

Yet another embodiment of the present invention can further include a water conveying channel disposed within the upper platform, an inlet valve and a plurality of openings that function in unison to deposit water and/or gas into the aperture.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a mobile plant growing apparatus that is useful for understanding the inventive concepts disclosed herein.

FIG. 2 is a perspective view of the table portion of the apparatus, in accordance with one embodiment of the invention.

FIG. 3 is a perspective view of the mobile plant growing apparatus in operation, in accordance with one embodiment of the invention.

FIG. 4 is a perspective view of the mobile plant growing apparatus in accordance with another embodiment of the invention.

FIG. 5 is a perspective view of the mobile plant growing apparatus in accordance with another embodiment of the invention.

FIG. 6 is a perspective view of the mobile plant growing apparatus in accordance with an alternate embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

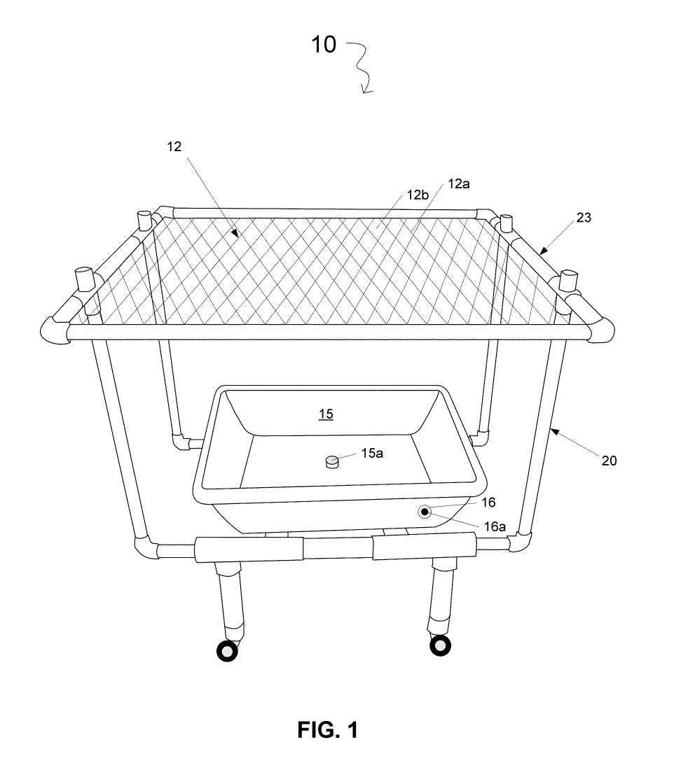

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

An apparatus for housing and growing medicinal plants is described herein. As will be described below, one embodiment can function to provide an apparatus capable of housing and growing medicinal and/or non-medicinal plants in a novel fashion without requiring a user to remove the plant from the apparatus during the life of the plant.

FIG. 1 illustrates one embodiment of a mobile plant growing apparatus that is useful for understanding the inventive concepts described herein. As shown, apparatus 10 can include a table 20, having an integrated branch screen 12 and a storage tray 15.

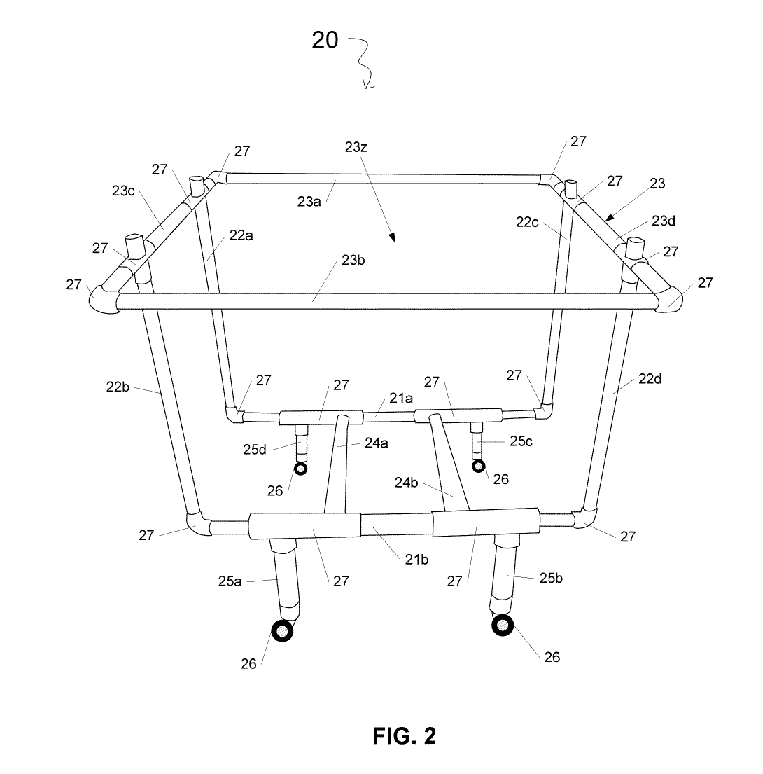

As shown best in FIG. 2, the table 20 can include a pair of elongated generally parallel base members 21a and 21b that are connected to a plurality of upward radiating angled vertical members 22a-22d which terminate into an upper platform 23 that is constructed from members 23a-23d. The upper platform preferably defining a large aperture 23z which is positioned above, and covers an area that is greater than the bottom section of the table.

A pair of cross support members 24a and 24b bisect the base members, and a plurality of legs 25a-25f having wheels 26 thereon function to allow full movement and rotation of the table. As described herein, the combination of the base members 21 and support members 24 comprise the bottom section of the apparatus and further act to form a shelf onto which the waterproof tray will be housed.

In one preferred embodiment, each of the members 21-25 can be constructed from individual pieces of resilient waterproof material such as PVC, for example, that are joined together via commercially available connectors 27 (e.g., PVC schedule 40 fittings and/or DWV fittings). Such a feature can allow the apparatus to be shipped in a relatively small container and then assembled by an end user without the need for specialized tools or equipment. Of course, any number of other construction materials such as metal, injection molded plastic and wood, for example can also be utilized and assembled in accordance with known manufacturing processes.

Returning to FIG. 1, a screen 12 can be positioned across the upper platform 23 in order to act as a barrier/guide for ensuring the plant branches to grow in a desired manner, such as outward in a flat plane, as opposed to vertically. To this end, the screen can include a plurality of crisscross members 12a defining openings 12b. As will be described below in detail, when a plant is housed within the apparatus 10, the top portions of the plant containing the leaves will grow to the same height and will therefore be able to each receive maximum light, thereby ensuring each plant produces the best possible crop.

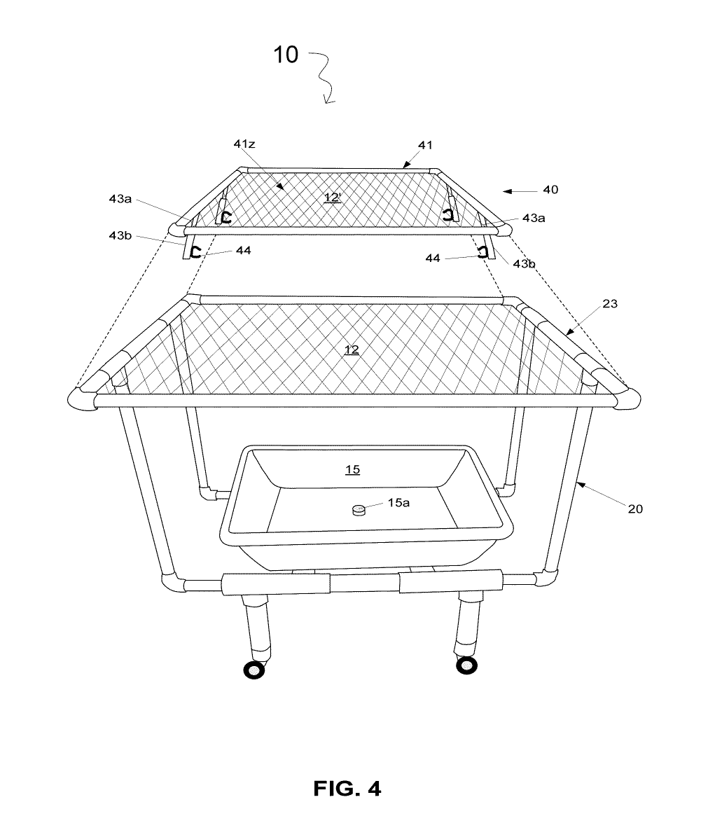

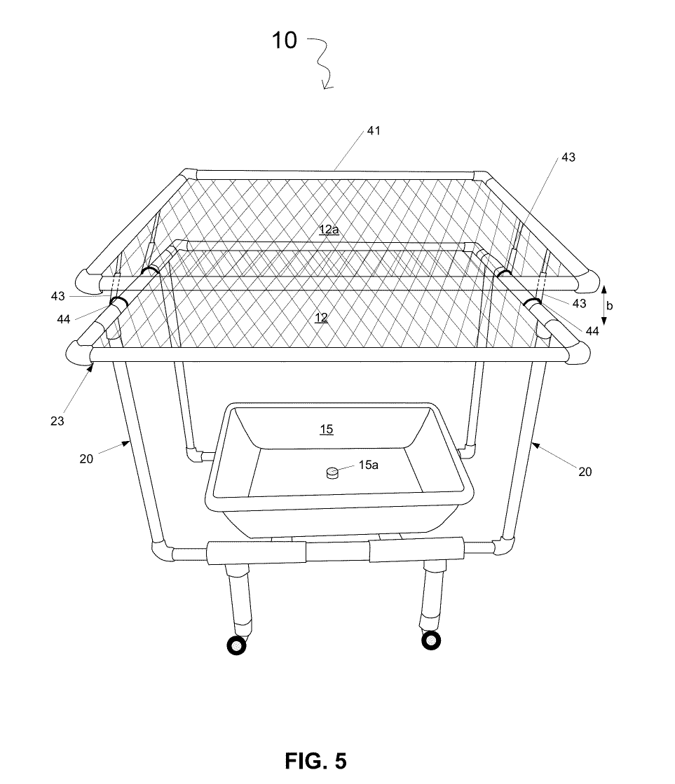

In the preferred embodiment, the screen 12 can be constructed from lightweight poultry netting or other similar devices, and each of the openings defined by the screen include a dimension of approximately two square inches. By providing openings of approximately two square inches within the screen, the apparatus advantageously functions to position leaves and branches in a generally horizontal manner while providing minimum impedance to light. Additionally, as described below with respect to FIGS. 4 and 5, the sizing of the screen openings will allow buds or other such crops to pass through the bottom of the screen and be supported when resting on the top surface.

Of course, other embodiments are contemplated wherein the screen 12 can be constructed from any number of crisscross materials such as plastic or lightweight metal, for example forming a lightweight fence for engaging the plant materials. The screen 12 can be secured to the platform 23 utilizing any number of conventional devices such as rope, clips, staples, welds and the like, for example.

A plant storage tray 15 can be positioned on the base and cross members of the table 20. The storage tray will preferably include an elongated, generally rectangular high sided waterproof bin that is capable of receiving potted plants and positioning the same beneath the screen 12. In one preferred embodiment, the storage tray 15 can be constructed from lightweight plastic and can include a removable plug 15a along the bottom portion thereof, in order to allow any water within the tray to be removed.

Alternatively, or in addition to the removable plug, the storage tray 15 can also include a valve 16 having a connector 16a for communicating with an external device such as a water hose, for example. As described herein, the connector 16a can include a plurality of threaded elements configured to rotatably engage opposing threaded elements of a hose or other such device, in order to create a solid and waterproof connection. Such a feature can allow the plant contained within the tray to be watered and/or flushed inside the growing area while simultaneously evacuating excess fluids via a hose that is connected to the valve.

Although described herein as a separate element that is removable from the table, other embodiments are also contemplated wherein the tray 15 is formed as an integral component of the table through any number of known manufacturing processes. To this end, although described above as including specific shapes, sizes and materials, one of skill in the art will recognize that any number of different materials, dimensions and shapes (such as a circular shaped platform 23 and screen 12, for example) can be utilized herein without deviating from the scope and spirit of the described invention.

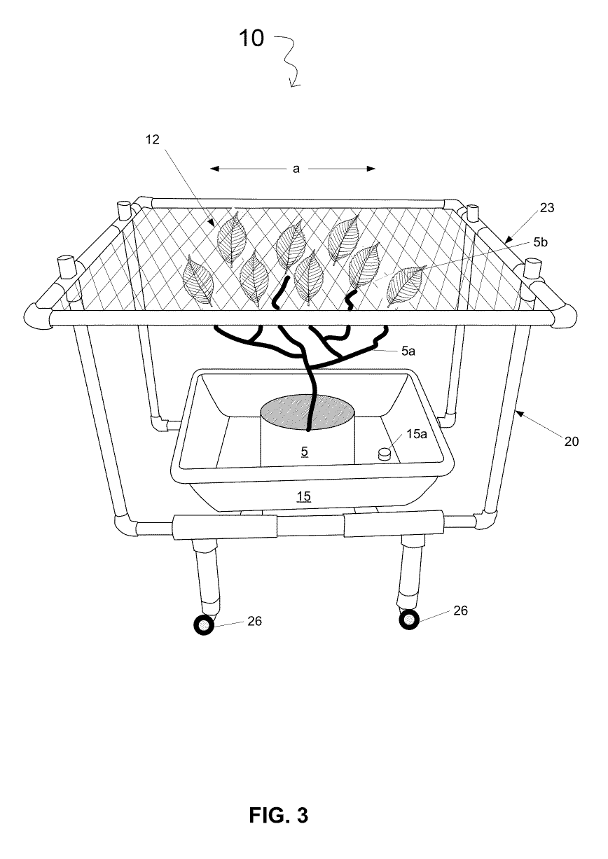

In operation, and as shown in FIG. 3, a plant 5 can be positioned within the container 15 that is located beneath the screen 12. Once positioned within the apparatus, the plant need not ever be removed, as the plant will receive water, nutrients, light, trimming and harvesting while securely positioned within the apparatus itself.

As such, during the growth period of the plant, the branches 5a can be spread out across the surface area of the screen 12 in order to ensure that the plant leaves 5b are dispersed in a generally horizontal/flat manner (see arrow a). As noted above, the aperture 23z and screen 12 cover an area that is greater than the bottom section of the table. Such a feature advantageously allows the plant branches to spread outward and be engaged with the screen so as to ensure that the largest possible surface area of the plants leaves are exposed to the sun and/or grow lights at all times, thus ensuring the maximum possible crop yield.

Additionally, by including articulating wheels 26, the apparatus 10 can be mobile, thus allowing a user to maximize space within the usually cramped indoor environment. To this end, each plant can be continually moved, rotated and the like while being exposed to the light. Additionally, such a feature allows the user to work on plants from a sitting position, by rotating the apparatus in order to give the user access to all sides of the plant. This can be accomplished without ever having to physically lift the plants.

In contrast, without the aid of the apparatus 10, a user would be required to lift the plant from one portion of the indoor grow area to another (indoor medicinal plants require different light spectrums at different growing stages) during the natural growing cycle. While this may not be difficult for infant plants, it can become exceedingly difficult as the plants reach maturity and achieve weights of between 10 and 25 pounds or more.

In addition to the above, by including a waterproof storage tray 15 with a removable plug 15a, and/or valve 16, the presently claimed invention advantageously allows a user to flush plants indoors. To this end, any and all spent water can be contained within the storage tray and evacuated from the apparatus using the plug and deposit the same into a bucket for outside disposal. Moreover, when flushing the plant which requires extremely large volumes of water, the valve can be utilized to connect to a conventional garden hose, for example, so as to automatically remove the water from the plant during the flushing procedure. As such, the introduction of these features eliminates the need for a user to move and/or lift the plant between an inside and outside environment which can cause cross-contamination with other plants, and/or damage to the plant 5 itself.

FIGS. 4 and 5 illustrate an alternate embodiment of the apparatus 10 that further includes a removable second platform 40. In one embodiment, the second removable platform can include a frame 41, aperture 41z and screen 12′ having a shape and dimension that is approximate to the shape and dimension of the table platform 23. The platform also including a plurality of telescoping vertical separators 43 extending downward therefrom. Each of the vertical separators 43 including a generally C-shaped clamp 44 having a size and dimension suitable for engaging the table platform 23 in a conventional manner. As shown in FIG. 5, once positioned onto the table 20, the second platform 40 is suspended above the table platform and functions to provide a secondary means for aligning the branches, leaves or crops of the plant in the best possible manner to the light.

By introducing a second screen, the inventor has discovered a novel manner to increase the size and quality of buds within a plant such as medicinal marijuana, for example. To this end, when the plant branches and leaves are spaced apart by the first screen 12, the buds can continue to grow upward. As the buds continue to grow, they would eventually be unable to support their own weight, and will break; however, by providing a second screen 12′, the weight of the buds can be fully supported, thus ensuring their continued growth. Moreover, by providing telescoping extenders 43, a user shall be able to raise and lower the second (upper) platform and screen as the plant grows, without ever having to remove either the screen itself of the plant.

As described herein, the frame 41 and screen 12′ can be constructed in an essentially identical manner to the frame 23 and screen 12, described above. Additionally, each of the extenders 43 can include a first half 43a and a second half 43b. As will be known to those of skill in the art, the term “telescoping” can refer to two elongated hollow shafts having varying diameters wherein a portion of one shaft (43a) is located within the other (43b), and can extend or retract therefrom. Although the separators 43 will preferably be telescoping in nature, they can also include a fixed length, and each be constructed from a single elongated member of PVC, for example.

Although described above as including a C-shaped clamp, this is for illustrative purposes only, as any number of other attachment devices can also be utilized. Several non-limiting examples include traditional mounting brackets and hardware such as screws, bolts and fasteners, for example.

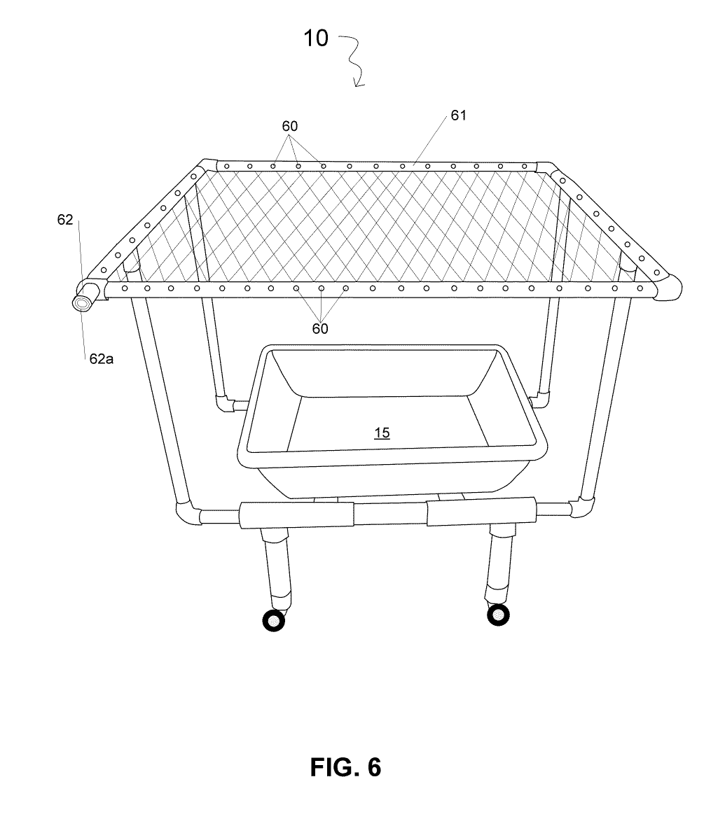

FIG. 6 illustrates another alternate embodiment of the apparatus 10 that further includes a plurality of openings 60 connected via an internal channel 61 that is disposed within the upper frame 23. The internal channel can be connected to an inlet valve 62 having a connector 62a for communicating with an external device. For example, the connector 62a can include a plurality of threaded elements configured to rotatably engage opposing threaded elements of a hose or other such line, in order to create a solid and waterproof connection. In one preferred embodiment, the inlet valve 62 can act to receive gas and/or liquids, such as compressed CO2, and distribute the same to the plant leaves and branches. Of course, the inlet and channel can also function to receive and distribute any number of different gasses, liquids and the like for any number of different applications.

Although illustrated as being included within the frame 23, the above described features can also be included within the secondary platform 40.

Although not illustrated, yet another embodiment of the apparatus 10 can further include one or more lighting elements suspended above the screens via one or more light support members. Each of the one or more lighting elements can be specially constructed to encourage plant growth and can include virtual sun lighting elements, optional reflectors, monitors, power supply elements and the like, capable of allowing each apparatus 10 to be a self sustained growing device for a provided plant.

As described herein, one or more elements of the apparatus 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the table 20, the screen 12 and/or the container 15, for example, may be formed together as one continuous element, either through manufacturing processes, such as welding, casting, or molding, or through the use of a singular piece of material milled or machined with the aforementioned components forming identifiable sections thereof. Additionally, each of the above described elements can also be constructed individually and assembled to form the apparatus.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A mobile plant growing apparatus, comprising:
a table that includes
a plurality of vertical members interposed between a bottom section and an upper platform, said platform defining an aperture which is positioned above the bottom section, and
a plurality of wheeled legs extending downward from the bottom section;
a waterproof storage tray positioned on the bottom section; and
a screen positioned across an entirety of the aperture of the upper platform.

2. The apparatus of claim 1, wherein the waterproof storage tray includes an elongated, generally rectangular high sided bin that is configured to receive and store potted plants of varying dimensions.

3. The apparatus of claim 2, further comprising:
a removable plug disposed within a bottom area of the waterproof bin, said plug being configured to evacuate liquids from the bin.

4. The apparatus of claim 3, further comprising:
a valve and connector disposed within the waterproof bin, said valve and connector functioning to provide a secure and watertight connection with an external hose for evacuating liquids from the bin.

5. The apparatus of claim 2, further comprising:
a valve and connector disposed within the waterproof bin, said valve and connector functioning to provide a secure and watertight connection with an external hose for evacuating liquids from the bin.

6. The apparatus of claim 1, wherein the aperture covers an area that is greater than a surface area of the bottom section of the table.

7. The apparatus of claim 1, wherein the screen is constructed from lightweight poultry netting and each of a plurality of screen openings include a dimension of approximately two square inches.

8. The apparatus of claim 1, wherein the table is constructed from a plurality of elongated PVC members that are removably secured together via connectors.

9. The apparatus of claim 1, wherein each of the table, the waterproof tray and the screen are constructed from a single mold of injected plastic.

10. A mobile plant growing apparatus, comprising:
a table that includes
a plurality of vertical members interposed between a bottom section and a first upper platform, said platform defining an aperture which is positioned above the bottom section, and a plurality of wheeled legs extending downward from the bottom section;
a waterproof storage tray positioned on the bottom section of the table;
a first screen positioned across an entirety of the aperture of the first upper platform;
a second upper platform that is removably positioned above the first upper platform via a plurality of vertical separators, said second upper platform defining a second aperture; and
a second screen positioned across an entirety of the aperture of the second upper platform.

11. The apparatus of claim 10, wherein each of the plurality of separators includes a fixed length.

12. The apparatus of claim 10, wherein each of the plurality of separators are constructed from a pair of telescoping members and are configured to position the second screen at a variable distance above the first screen.

13. The apparatus of claim 10, wherein the waterproof storage tray includes an elongated, generally rectangular high sided bin that is configured to receive and store potted plants of varying dimensions.

14. The apparatus of claim 13, further comprising:
a removable plug disposed within a bottom area of the waterproof bin, said plug being configured to evacuate liquids from the bin.

15. The apparatus of claim 14, further comprising:
a valve and connector disposed within the waterproof bin, said valve and connector functioning to provide a secure and watertight connection with an external hose for evacuating liquids from the bin.

16. The apparatus of claim 13, further comprising:
a valve and connector disposed within the waterproof bin, said valve and connector functioning to provide a secure and watertight connection with an external hose for evacuating liquids from the bin.

17. The apparatus of claim 10, wherein each of the first and second apertures cover an area that is greater than a surface area of the bottom section of the table.

18. A mobile plant growing apparatus, comprising:
a table that includes
a plurality of vertical members interposed between a bottom section and an upper platform, said platform defining an aperture which is positioned above the bottom section, and
a plurality of wheeled legs extending downward from the bottom section;
a waterproof storage tray positioned on the bottom section;
a screen positioned across an entirety of the aperture of the upper platform;
a waterproof channel disposed within the platform;
a plurality of openings disposed within the upper platform and the waterproof channel;
a valve secured within the upper platform that is in communication with the waterproof channel,
wherein the valve, waterproof channel and plurality of openings are configured to receive at least one of a gas and liquid, and to deposit the same into the aperture.

19. The apparatus of claim 18, wherein the waterproof storage tray includes an elongated, generally rectangular high sided bin that is configured to receive and store potted plants of varying dimensions, and further includes:
a removable plug disposed within a bottom area of the waterproof bin; and
a valve and connector disposed within the waterproof bin.

20. The apparatus of claim 18, wherein the aperture covers an area that is greater than a surface area of the bottom section of the table.
